(19) United States
(12) Patent Application Publication
(10) Pub. No.: US 2009/0024759 A1
(43) Pub. Date: Jan. 22, 2009

(54) System and method for providing alerting services

(76) Inventors: Michael T. McKibben, Columbus, OH (US); James Sobwick, Radnor, OH (US); Paul Petronelli, San Jose, CA (US); Tim Fathbruckner, Delaware, OH (US); Steve Nester, Delaware, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 12/215,389

(22) Filed: Jun. 26, 2008

Related U.S. Application Data
(60) Provisional application No. 60/946,371, filed on Jun. 26, 2007.

(51) Int. Cl. G06F 15/173; H04M 11/00; G06F 15/16

(52) U.S. Cl. 709/238; 379/93.01; 709/239; 709/208

(57) ABSTRACT

A communications system for providing alerting services that includes a plurality of server devices distributed throughout a geographical area, a transmission network including a plurality of transmission routes, and an alerting component adapted to generate and transmit the alert information. The plurality of server devices are adapted to receive, store and transmit alert information associated with an external event and the plurality of server devices store substantially the same alert information at any given time. The alerting component also directs the plurality of server devices to transmit the alert information to at least one user device. The transmission network is adapted to transmit the alert information using one or more of the plurality of transmission routes between any two server devices.

### CROSS-REFERENCE TO RELATED APPLICATIONS

This application claims the benefit of U.S. Provisional Application Ser. No. 60/946,371 entitled “COMMUNICATIONS ARCHITECTURE,” filed on Jun. 26, 2007, the disclosure of which is incorporated herein by reference.

### FIELD OF THE INVENTION

The present invention is generally directed to a system and method for providing communication services. Specifically, the present invention is directed to a system and method of providing alerting services in a communication system.

### BACKGROUND OF THE INVENTION

In the recent past, natural and man-made events have caused chaotic emergency situations. Examples of such emergency situations include the events associated with Hurricane Katrina and the fall of the World Trade Center buildings. During and immediately after such catastrophic events, channels of communication are essentially rendered useless due to the unusual numbers of users trying to access them. These recent disasters demonstrated our communication vulnerabilities during threatening events, and our great need to deliver timely, potentially life-saving information to the large populations affected by these events.

It has been shown that our current communication systems during catastrophic and/or emergency events have failed us. Specifically, the current systems cannot provide densely populated areas timely alerting and collaboration services and communications services in populated areas often fail during a crisis. Therefore, a solution is needed that provides reliable communications in and out of a crisis zone and that provides a communication architecture that will not fail even if a portion is destroyed or temporarily unusable.

### SUMMARY OF THE INVENTION

Aspects of the present invention address these needs by providing a system and method for providing alerting services.

It is a first aspect of the present invention to provide a communications system for providing alerting services that includes a plurality of server devices distributed throughout a geographical area, a transmission network including a plurality of transmission routes, and an alerting component adapted to generate and transmit the alert information. The plurality of server devices are adapted to receive, store and transmit alert information associated with an external event and the plurality of server devices store substantially the same alert information at any given time. The alerting component also directs the plurality of server devices to transmit the alert information to at least one user device. The transmission network is adapted to transmit the alert information using one or more of the plurality of transmission routes between any two server devices. In one embodiment, the transmission network may be a telecommunications network.

In one embodiment of the first aspect, the user device may operate on communication networks such as a public switched telephone network (PSTN) network, an Internet Protocol (IP) network, a cellular network, a radio network and/or a satellite network. In one embodiment, the user device may operate on the Internet. In one embodiment, the user device may be a telephone, a website, a computer device, a personal digital assistant, a cellular device and/or a satellite device.

In one embodiment of the first aspect, the alert information may be generated as a voicemail, a voice message, a text (SMS) message, website content and/or an email. In another embodiment, the alert information may be generated by an operator in relation to the external event. In another embodiment, the alert information may pre-generated for a specific type of external event.

In one embodiment of the first aspect, the alerting component may be implemented as an Internet service. In another embodiment, the alerting component may be managed via an Internet-based interface.

In one embodiment of the first aspect, the external event may be an emergency event, a criminal event, a natural disaster, a man-made disaster, a weather event, a scheduling event, a traffic event and/or a security event.

It is a second aspect of the present invention to provide a method of providing alerting services that includes the steps of: (a) providing a plurality of server devices distributed throughout a geographical area and adapted to transmit, receive and store communication data including alert information; (b) providing a transmission network having a plurality of communication links capable of transmitting the communication data among the plurality of server devices, where the transmission network is adapted to transmit the communication data via a plurality of transmission routes between any two server devices; (c) providing an alerting service adapted to generate the alert information associated with an external event, where the alerting service is in communication with the plurality of server devices via the transmission network; (d) transmitting, via the transmission network, the communication data from at least one of the plurality of server devices to each of the other server devices so the plurality of the server devices store substantially the same communication data; (e) generating, by the alerting service, the alert information; (f) determining if one or more of the plurality of transmission routes is available; (g) transmitting, via one or more available transmission routes, the alert information from at least one of the plurality of server devices to each of the other server devices so the plurality of the server devices store the same alert information; and (h) transmitting the alert information to one or more communication clients.

In one embodiment of the second aspect, communication clients may be operating on a public switched telephone network (PSTN) network, an Internet Protocol (IP) network, a cellular network, a radio network and/or a satellite network. In one embodiment, the communication clients may be a telephone, a website, a computer device, a personal digital assistant, a cellular device and/or a satellite device.

In one embodiment of the second aspect, the alert information may be generated as a voicemail, a voice message, a text (SMS) message, website content and/or an email. In another embodiment, the alerting service may be implemented as an Internet service. In another embodiment, the alerting service may be managed using an Internet-based management interface.

In one embodiment of the second aspect, the external event may be an emergency event, a criminal event, a natural disaster, a man-made disaster, a weather event, a scheduling event, a traffic event and/or a security event.

In another embodiment of the second aspect, the method also includes the steps of: (i) receiving, by the alerting service, notification information associated with the status of transmission of the alert information transmitted to the one or more communication clients; (j) generating timestamps associated with each of the generation of alert information, the transmission of alert information to the plurality of server devices, the transmission of alert information to the one or more communication clients, and receiving the notification information; and (k) recording, in a log file, the alert information, the notification information, the timestamps, and transmission information associated with all transmissions of the alert information.

It is a third aspect of the present invention to provide a communication system for alerting users of an emergency event that includes a plurality of server devices located in various geographical locations, a network of transmission links connecting the plurality of server devices, a computer-implemented alerting component, and a computer-implemented logging component for logging transmission information associated with the transmission of the alert information. Each of the plurality of server devices is adapted to store substantially the same communication data. The network of transmission links connects the plurality of server devices with at least one other of the server devices and is capable of connecting at least one of the plurality of server devices to user communication devices for transmitting alert information. The computer-implemented alerting component generates alerts associated with the emergency event and may direct the server devices to transmit the alert information, via the network of transmission links, to the user communication devices.

It is a fourth aspect of the present invention to provide a process (and associated system) for providing communication services. This includes providing a plurality of communication server devices distributed throughout a geographical area and adapted to receive, store and transmit alert or call information; providing a communication management component adapted to transmit the alert or call information, and further adapted to direct one or more of the plurality of communication server devices to transmit the alert or call information to at least one user device; providing a transmission network including a plurality of transmission routes between the plurality of communication server devices, the communication management component and the at least one user device, the transmission network being adapted to transmit the alert or call information via one or more of the plurality of transmission routes between at least two communication server devices; configuring one or more of the communication server devices to act as master nodes controlling a plurality of other communication server devices and configuring the other communication server devices to act as slave nodes; and reconfiguring at least one of the communication server devices acting as slave nodes to act as a master node upon detection, in any manner, of degraded performance of a master node. In a more detailed embodiment the reconfiguring step is performed in response to a detection of degraded performance of a master node to be 30% or less than another node.

It is a fifth aspect of the present invention to provide a process (and associated system) for providing communication services. This includes providing a plurality of communication server devices distributed throughout a geographical area and adapted to receive, store and transmit alert or call information; providing a communication management component adapted to transmit the alert or call information, and further adapted to direct one or more of the plurality of communication server devices to transmit the alert or call information to at least one user device; providing a transmission network including a plurality of transmission routes between the plurality of communication server devices, the communication management component and the at least one user device, the transmission network being adapted to transmit the alert or call information via one or more of the plurality of transmission routes between at least two communication server devices; and configuring at least one of the communication server devices to re-route alert or call information from one transmission route to another transmission route in response to detected degradation of performance of the one transmission route.

It is a sixth aspect of the present invention to provide a process (and associated system) for providing communication services. This includes routing a telephone call initiated by a user's telephone device to a call management computer system; sensing by the call management computer system of a predetermined series of one or more telephone keys activated on the user's telephone device; as a result of sensing the predetermined series of telephone keys activated on the user's telephone device, initiating a value-added functionality to the telephone communication by the call management computer system. In a more detailed embodiment, the step of initiating a value-added functionality includes a step of connecting the telephone call to an additional user's telephone device. In an alternate detailed embodiment the telephone call connects the user's telephone device to a second user's telephone device and the step of initiating the value-added functionality includes a step of connecting the telephone call to at least a third user's telephone device. In an alternate detailed embodiment the predetermined series of keys includes a star key “*” followed by a number key. In another alternate detailed embodiment, the value added functionality is adding a participant, dropping a participant, adjusting speaker volume, adjusting microphone volume, recording the communication, muting a participant, un-muting a participant, and/or requesting an options menu. And in another alternate detailed embodiment, the method further includes the step of calculating a financial charge by the call management system for use of the value added functionality.

From the foregoing disclosure and the following detailed description of various preferred embodiments it will be apparent to those skilled in the art that the present invention provides a significant advance in the art of communication systems and methods. Additional features and advantages of various preferred embodiments will be better understood in view of the detailed description provided below.

### BRIEF DESCRIPTION OF THE DRAWINGS

The present invention will be understood and appreciated more fully from the detailed description in conjunction with the following drawings in which:

FIG. 1 depicts a system diagram according to an exemplary embodiment of the present invention;

FIG. 2 depicts a graphical user interface according to one aspect of an exemplary embodiment of the present invention;

FIG. 3 depicts a system diagram according to another exemplary embodiment of the present invention;

FIG. 4 depicts a block diagram of a computing environment operable to execute an exemplary embodiment of the disclosed invention;

FIG. 5 depicts a flow diagram according to yet another exemplary embodiment of the present invention; and

FIG. 6 depicts a system diagram according to still yet another exemplary embodiment of the present invention.

### DETAILED DESCRIPTION

It will be apparent to those skilled in the art that many uses and variations are possible for the system and method of the present invention. The following detailed discussion of various exemplary embodiments will illustrate the general principles of the invention. Other embodiments will be apparent to those skilled in the art given the benefit of this disclosure.

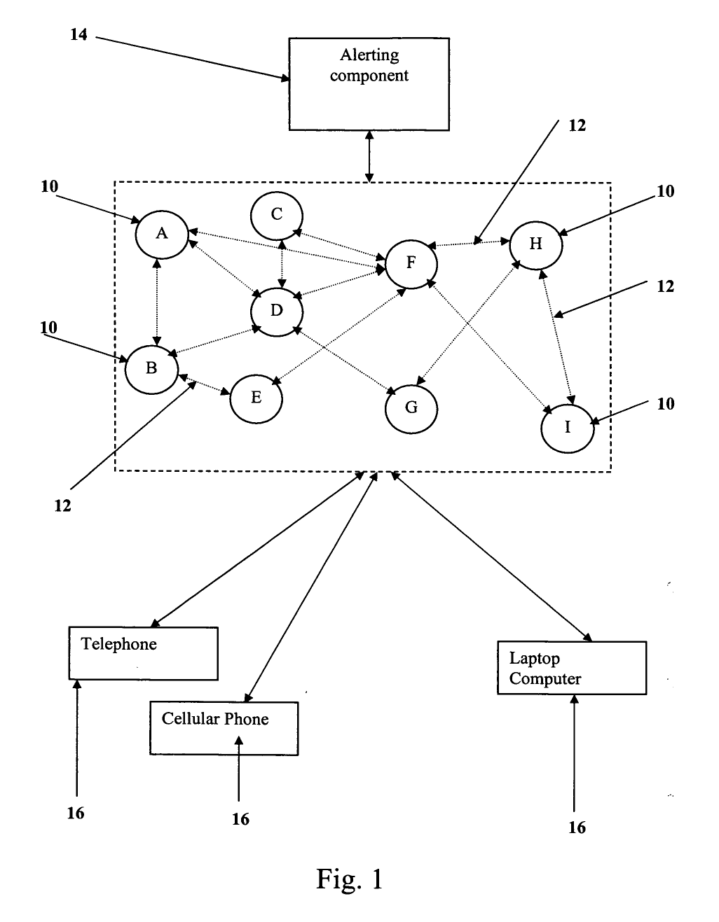

An exemplary embodiment of the present invention is directed to a communication system for providing alerting and/or call services. As shown in FIG. 1, this exemplary embodiment may include a plurality of server devices 10, a transmission network having a plurality of transmission routes 12, and an alerting component 14. The plurality of server devices 10 may be distributed throughout a geographical area, such as the United States, the Midwest, California, New York City, or Yellowstone National Park, for example. The server devices 10 are adapted to receive, store and transmit alert information associated with an external event. The transmission network is adapted to transmit the alert/call information via one or more of the plurality of transmission routes 12 between any two server devices 10 (for example, the transmission route 12 between server devices B and E in FIG. 1). The alerting component 14 (or a similar call management component, not shown) generates and transmits the alert/call information. The alerting/call-management component 14 may also direct one or more of the plurality of server devices 10 to transmit the alert/call information to one or more user device 16. For redundancy and/or backup purposes, a plurality of the server devices 10 may transmit and receive alert/call information therebetween such that several or all server devices 10 store substantially the same alert/call information at any given time. In an exemplary embodiment, one or more (if redundancy, for example, is desired) of the server devices 10 are configured to be “master” server devices, while the remainder of the server devices 10 are configured to be “slave” devices, where the master devices or nodes control the slave devices or nodes to respond to events and/or shift notification traffic in response to changes in traffic or degradation in performance of certain nodes 10 or transmission routes 12. As will be discussed below, in an exemplary embodiment, at least some of the slave nodes will be configured to be able to reconfigure themselves as master nodes if necessary to correct for degradation of master node performance or for any other reason.

As further seen in FIG. 1, the user devices 16 (or client devices) discussed in an exemplary embodiment of the present invention may include a telephone, a website, a computer device, a personal digital assistant, a cellular device, a satellite device, and/or other similar device. These user devices 16 (a telephone, a cellular phone, and a laptop computer in FIG. 1) may be capable of receiving alert information (or alerts) in various formats. For example, the telephone may be capable of receiving a voicemail alert, the cellular phone may be capable of receiving a text (SMS-short message service) message alert, and the laptop may be capable of receiving an email alert. Some user devices 16 may also be capable of receiving multiple formats of alerts, such as a cellular phone being able to receive voicemail alerts and text message alerts. Alerts may be generated by the alerting component 14 and received by the user devices 16 in a vast number of formats. Examples of these formats include a voicemail, a voice message, a text (SMS) message, website content, an email, and/or other similar format. It is also within the scope of the invention that user devices 16 may also receive and/or transmit calls in a plurality of formats.

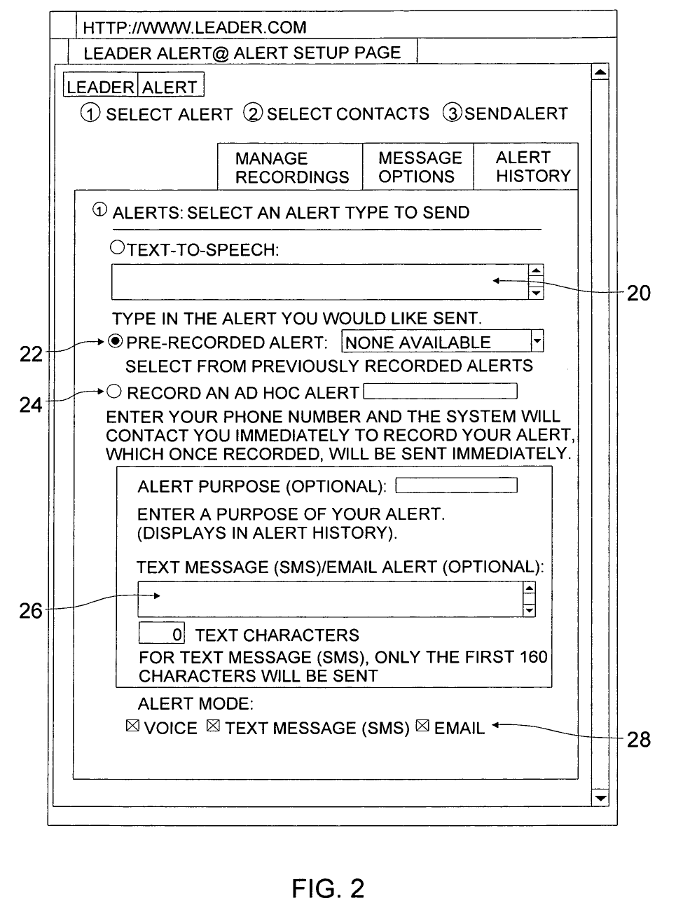

FIG. 2 depicts a graphical user interface according to one exemplary embodiment in which the alerting component 14 provides a user with several alert format options. These include a text-to-speech alert 20 (where the user types text into a software tool and the software tool converts the text into an audible output format representing a synthesized voice “reading” the text aloud), a pre-recorded voice alert 22 (where the user may upload or select a pre-generated audio format as the alert), a newly-recorded voice alert 24 (where the alerting component 14 allows a user to record a voice alert “on-the-spot” via a telephone call), a text message (SMS) alert 26 (where a user may provide text to the alerting component 14 for sending to text-message capable devices) and/or email alert 28 (where a user may provide text to the alerting component 14 for sending to email addresses). Any one or more of these alert formats may be utilized in an exemplary embodiment of the invention. In fact, FIG. 2 depicts a scenario in which voice message alerts, text messages alerts and email alerts are to be transmitted to user devices simultaneously.

Referencing back to FIG. 1, in one exemplary embodiment, aspects of the present invention help insure maximum communication coverage in and out of areas affected by an emergency or disaster event by finding the open transmission routes (or pathways) in and out of those areas. This means that if an alert/call attempts one transmission route 12 into an affected area and that transmission route 12 is blocked or down, it will look for an alternative route. Disasters are unpredictable by nature. Alerting must be adaptable to unpredictable conditions. Therefore, in one exemplary embodiment, each server device 10 has complete knowledge of the contents and/or status of every other server device 10. Although FIG. 1 illustrates that each server device 10 is only connected to a few transmission routes 12, each server device 10 may (and likely will) be connected to dozens of transmission routes 12 such as those provided by telecommunications companies. This aspect of redundancy enables maximum penetration into an affected area.

Another aspect of one exemplary embodiment provides that the alerting component 14 be implemented as an Internet service, or otherwise be implemented as an Internet-based interface. The Internet may be a valuable tool in emergency and disaster situations, as an Internet site may essentially be accessed anytime and anywhere, with no “extra” application to install on one's computer (other than a web browser, which is typically installed on most computers from date of purchase). Implementation as an Internet service or interface also provides that embodiments of the invention allow for the creation and use of user accounts, which may provide security, authentication, personalization and management functions to users. Specifically in reference to security and authentication, an Internet service or Internet interface may provide users various encryption techniques (such as 128-bit SSL encryption), firewalls, and other various security techniques to ensure that unauthorized users do not gain access to the system. Technology associated with the alerting component 14 and other components and processes discussed herein is provided in detail in U.S. application Ser. No. 10/979,611 (filed Nov. 2, 2004) the disclosure of which is incorporated herein by reference.

Another aspect of one exemplary embodiment provides for a logging component that may log various activities, events and/or transmissions related to alert/call information. These activities, events and/or transmissions may include real-time or non-real-time receipts from user devices 16 that alert information was or was not received, the status of user devices 16, any generation of alert information, any transmission of alert information, and the time associated with any of the above actions or inactions. This logging component may also provide functionality for reports being generated for any specific activity in any stated time period. For example, a user may utilize the logging component to create a report showing the time, date and transmission information for all alerts send during the June 1 through June 4 time period. Reports for other time periods, such as hourly, daily, weekly, monthly and the like may also be generated. These reports may act as an auditing trail to detect use or abuse of the system.

Another aspect of one exemplary embodiment provides that the present invention may be implemented as an Internet service in combination with a call center operations. In this embodiment, call center operators may receive information from users via phone calls, the Internet or the like, enter that information into an interface of the Internet service, and send alerts related to that information to one or more user devices 16. This aspect may be implemented on a relatively large scale, such as by a large corporation or by a state-wide organization, or on a relatively small scale, such as by a local community college. This aspect, for example, may allow a college campus to quickly detect an emergency event, record information about the emergency event, and quickly and reliably disseminate accurate information and alerts about the emergency event to a wide variety of users (college students, faculty and employees). As is readily seen by this example, injuries related to emergency situations like the shootings at Columbine High School or Virginia Tech University may have been decreased if users were quickly and reliably received accurate alerts about the respective unfolding emergency situations.

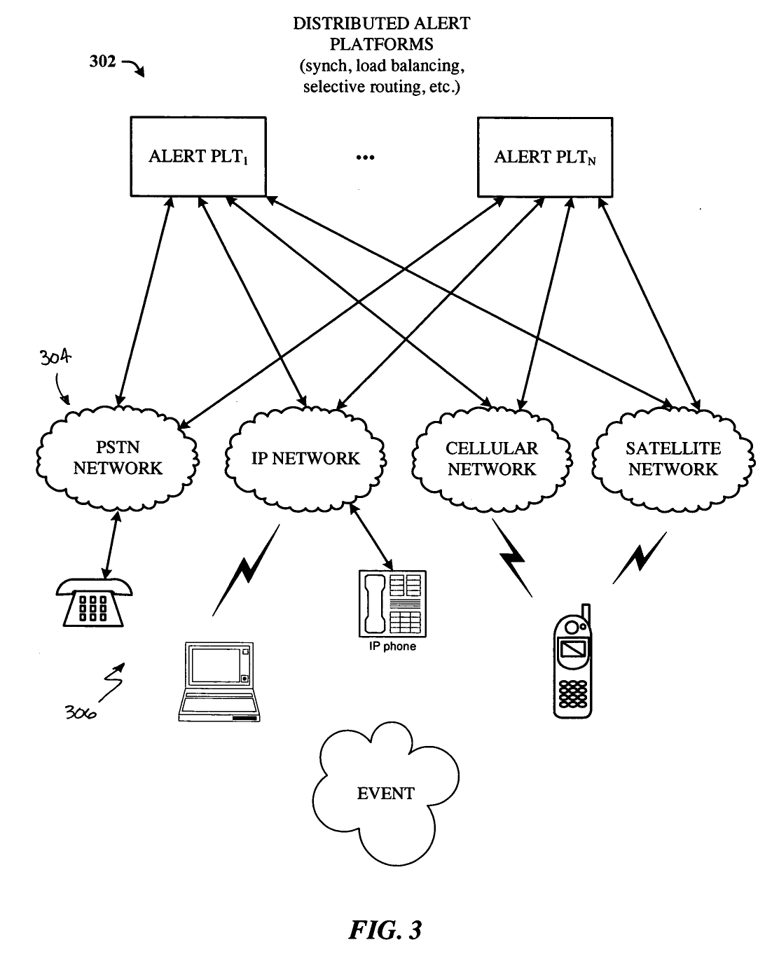

FIG. 3 depicts another exemplary embodiment of the present invention. Specifically, FIG. 3 illustrates a distributed system 300 for providing alert services associated with an event. The system 300 includes a distributed network of alert platforms 302 (denoted ALERT PLT1, . . . , ALERT PLTN, where N is a positive integer). The platforms 302 can interconnect to one or more communications networks 304 such as the PSTN, an IP network, a cellular network, a satellite network and/or other similar communication networks. This environment facilitates sending alerts to users of wireless phones, computers, IP phones and conventional handsets (306), for example. The platforms 302 may also include the capability to perform load balancing, data/software synchronization, and selective routing over more reliable and/or available networks associated with the event. The platforms can be strategically distributed across a geographical area (e.g., region, country, etc.) and connect or have access to connections to communications carriers such as phone companies, cable companies, and the like. This environment also facilitates multiple redundancy in connections for the event and the ability to react to changing situations surrounding the event that affect communications at any point in time.

While centralized switching systems are both simple and efficient, scalability quickly becomes an issue as consolidated call handler resources become consumed in the scheduling scheme. Additionally, a multitude of single points of failure exist, both man made and natural. On the other hand, a typical, decentralized architecture

able to make its own decisions, operate independently, and provide improved scalability; however, it generally does not contain the knowledge or status condition of other decentralized nodes on the network.

The “Starburst” architecture discussed in the above embodiments (FIG. 1), simply stated, can be thought of as blending a centralized switch architecture with a decentralized or federated switch architecture. In an exemplary embodiment, slave nodes throughout the network operate at the direction of a mirrored (at least two) master node. Status conditions are propagated real time throughout the network, enabling each node, or any combination of nodes to complete the entire distribution of tasks (calls, alerts, etc.). Each slave node has the instruction set necessary to be elevated to a master node should a master node outage occur. Without intended to be limiting, the exemplary application of the Starburst model has chosen to allow observed node performance as the criteria for node selection of activity. For example, if Node A is completing tasks at a rate equal to 30% or less of Node B, the Starburst architecture reallocates activity away from Node A, presuming that a degradation of performance has occurred at Node A (natural disaster or otherwise). In the exemplary embodiment, the 30% performance is a parameter that can be either increased or decreased by an administrator (it is a variable parameter accessible in the call management system). In summary, in an exemplary embodiment, real time propagation of network status condition is relayed to each node; and dynamic reallocation of activity sets is based on observed node performance.

Another aspect of the present invention is directed to a value added service that integrates with local exchange carriers (LECs), Dial Tone Service Providers (DTPs), or any telephony node that provides a dial tone to an end user. The service has the ability to intercept, and re-route the users call based on a pre-determined trigger initiated by the end user, and received at the telephone services provider's equipment.

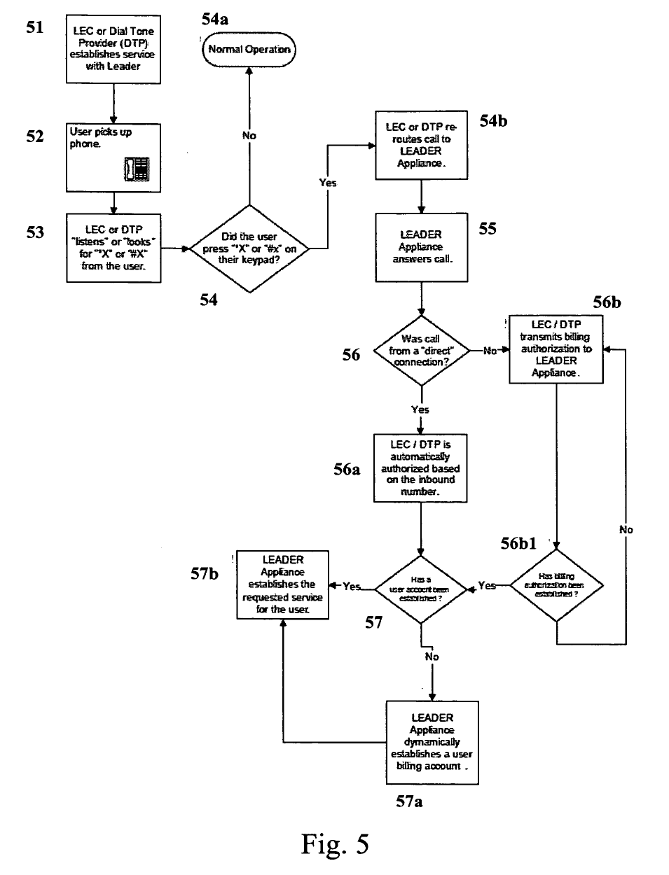

FIG. 5 depicts a flow diagram representing one embodiment of the present invention. Specifically, the illustrated embodiment is directed to a method of providing a communication service via a LEC/DTP architecture. One embodiment according to this aspect of the invention is generally described below.

As shown in FIG. 5, a call service provider establishes 51 an interconnection with the location of the value added service. This can be done in one of two ways: (1) The service provider can make a direct interconnect back to a remote call management system (such as Leader Appliance® by Leader Technologies®, www.leader.com, see also U.S. application Ser. No. 10/979,611) either via SIP (Session Initiation Protocol), or TDMA (time division multiple access), and designate one of their own telephone numbers to the system entry point for their customers, or (2) The service provider can elect to forward the call to one of the phone numbers associated with the remote call management system as the entry point for the system. Next, an end user or customer of the service provider picks up 52 their phone. The service provider sets their equipment to “look” for or “listen” 53 for the designated trigger from the end user. The designated trigger may be, for example, a predetermined sequence of key presses such as “*1” tones sent from the end users keypad. Once the phone registers an off hook condition, one of two things can happen: (1) if the user did not press “*1” (or the otherwise predetermined designated trigger) then normal operation occurs 54a, or (2) if the user did press “*1” then the service will redirect 54b the call via the interconnection method agreed upon to the remote call management system. The remote call management system may then answer 55, manage and control the call. The service provider may be granted access to the remote call management system in at least two ways based on the interconnection method previously determined. In step 56, if the connection is setup via the direct interconnect method defined in step 51(1), then the service provider's billing account may be automatically authenticated 56a based on the fact it originated from their designated phone number. If the connection is not setup via the direct interconnect method, then the service provider must first transmit 56b a predefined authorization code before being granted access. At this point 56b1, service will be denied if a valid authorization is not received and will be allowed if a valid authorization is received. Once service provider is authorized 56b1, the remote call management system will verify 57 an end user account has been established for their customer on our system. This will most likely be the telephone number of the service provider's customer (end user), although it is not required. If the end user does not have an account, then an account is dynamically generated 57a for them. If the end user has an account, then the remote call management system places 57b them into the requested service (such as a conference call).

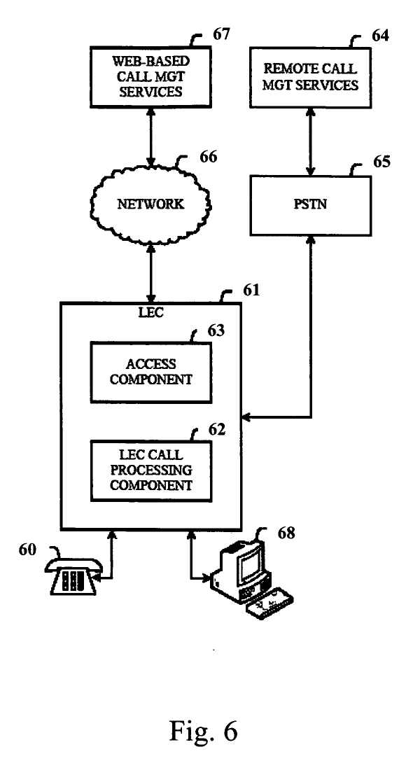

FIG. 6 illustrates a system for providing value-added services for local exchange carriers and providers of a dial tone to end users. A user at a handset 60 goes off-hook and enters a character string (*1, for example) via the handset keypad. The characters are received at the LEC 61, and based on the string, the call is intercepted by a LEC call processing component 62 and routed to the access component 63. The access component 63 auto-connects the call to the services 64 through the PSTN 65. Alternatively, the call can be routed over a network 66 (e.g., the Internet) to a web-based services system 67. In either case, the services 64 (e.g., call conferencing) can be accessed. The same process can be applied to a computer 68 that auto-dials directly or through a LAN (not shown) to the LEC 61.

The end user can be placed into a conference for example, by simply picking up a phone, and pressing one or more buttons to enter a predefined string of characters (e.g., *1) on their keypad and then keying in the 10-digit phone number of the first person the end user wishes to join the call. Once in the conference, the user can continue to press to enter the same or different character stings (e.g., *1) to add additional participants to the call up to the capacity of the conference bridge it is connected to. It is also within the scope of the invention that the user first initiates a call with another user (utilizing, in some respect, the call management service) and then adds additional participants to the conference call by entering the predefined strings of characters followed by the phone number of the additional participants. The service is not limited to conferencing, and can be used to integrate any number of value-added IVR (interactive voice recorder), or telephony applications, including but not limited to, voice mail, call recording, conferencing, operator assistance, or any other service that can be provided via a web-based service platform (e.g., the Leader Appliance® by Leader Technologies® of Westerville, Ohio). For example, an exemplary embodiment of the invention is configured to perform the following functions in response to the following keypad controls:

| | Function Performed by Remote Call |
|---|---|
| Keypad Controls | Management System |
| *1 | Add a Participant |
| *2 | Speaker Volume UP |
| 2 2 | Microphone Volume UP |
| *3 | Drop Participant Added |
| *4 | Record Start/Stop |
| *7 | Mute Yourself |
| *8 | Speaker Volume DOWN |
| 8 8 | Microphone Volume DOWN |
| *9 | Unmute Yourself |
| *0 | Request Operator |
| ** | Options Menu |

These services have the benefit of being able to be located either locally or remotely from the call provider. The re-route can be interconnected via any means such as TDMA, analog, or SIP connection and multiple providers can take advantage of “economies of scale” to add large company services to their offerings at a minimal cost.

When a call is complete, a record of the services rendered may be created and transmitted back to the telephone service provider where they can invoice the end user for the services rendered, based on the end user's telephone number.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

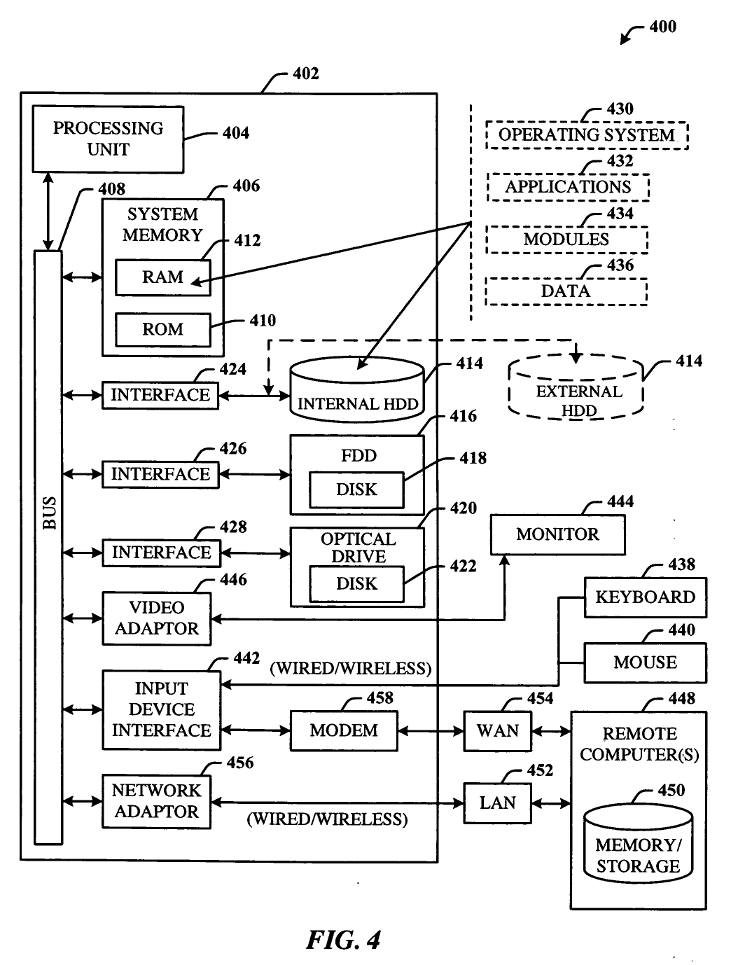

FIG. 4 illustrates a block diagram of a computing system 400 operable to execute the disclosed architecture. In order to provide additional context for various aspects thereof, FIG. 4 and the following discussion are intended to provide a brief, general description of a suitable computing system 400 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer readable media. Computer readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 4, the exemplary computing system 400 for implementing various aspects includes a computer 402, the computer 402 including a processing unit 404, a system memory 406 and a system bus 408. The system bus 408 provides an interface for system components including, but not limited to, the system memory 406 to the processing unit 404. The processing unit 404 can be any of various commercially available processors. Dual microprocessors and other multi processor architectures may also be employed as the processing unit 404.

The system bus 408 can be any of several types of bus structure that may further interconnect to a memory bus (with or without a memory controller), a peripheral bus, and a local bus using any of a variety of commercially available bus architectures. The system memory 406 includes read-only memory (ROM) 410 and random access memory (RAM) 412. A basic input/output system (BIOS) is stored in a non-volatile memory 410 such as ROM, EPROM, EEPROM, which BIOS contains the basic routines that help to transfer information between elements within the computer 402, such as during start-up. The RAM 412 can also include a high-speed RAM such as static RAM for caching data.

The computer 402 further includes an internal hard disk drive (HDD) 414 (e.g., EIDE, SATA), which internal hard disk drive 414 may also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The hard disk drive 414, magnetic disk drive 416 and optical disk drive 420 can be connected to the system bus 408 by a hard disk drive interface 424, a magnetic disk drive interface 426 and an optical drive interface 428, respectively. The interface 424 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 402, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and RAM 412, including an operating system 430, one or more application programs 432, other program modules 434 and program data 436. All or portions of the operating system, applications, modules, and/or data can also be cached in the RAM 412. It is to be appreciated that the disclosed architecture can be implemented with various commercially available operating systems or combinations of operating systems.

A user can enter commands and information into the computer 402 through one or more wire/wireless input devices, for example, a keyboard 438 and a pointing device, such as a mouse 440. Other input devices (not shown) may include a microphone, an IR remote control, a joystick, a game pad, a stylus pen, touch screen, or the like. These and other input devices are often connected to the processing unit 404 through an input device interface 442 that is coupled to the system bus 408, but can be connected by other interfaces, such as a parallel port, an IEEE 1394 serial port, a game port, a USB port, an IR interface, etc.

A monitor 444 or other type of display device is also connected to the system bus 408 via an interface, such as a video adapter 446. In addition to the monitor 444, a computer typically includes other peripheral output devices (not shown), such as speakers, printers, etc.

The computer 402 may operate in a networked environment using logical connections via wire and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically includes many or all of the elements described relative to the computer 402, although, for purposes of brevity, only a memory/storage device 450 is illustrated. The logical connections depicted include wire/wireless connectivity to a local area network (LAN) 452 and/or larger networks, for example, a wide area network (WAN) 454. Such LAN and WAN networking environments are commonplace in offices and companies, and facilitate enterprise-wide computer networks, such as intranets, all of which may connect to a global communications network, for example, the Internet.

When used in a LAN networking environment, the computer 402 is connected to the local network 452 through a wire and/or wireless communication network interface or adapter 456. The adaptor 456 may facilitate wire or wireless communication to the LAN 452, which may also include a wireless access point disposed thereon for communicating with the wireless adaptor 456.

When used in a WAN networking environment, the computer 402 can include a modem 458, or is connected to a communications server on the WAN 454, or has other means for establishing communications over the WAN 454, such as by way of the Internet. The modem 458, which can be internal or external and a wire and/or wireless device, is connected to the system bus 408 via the serial port interface 442. In a networked environment, program modules depicted relative to the computer 402, or portions thereof, can be stored in the remote memory/storage device 450. It will be appreciated that the network connections shown are exemplary and other means of establishing a communications link between the computers can be used.

The computer 402 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, for example, computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Following from the above description and invention summaries, it should be apparent to persons of ordinary skill in the art that, while the systems and methods herein described constitute exemplary embodiments of the present invention, it is to be understood that the inventions contained herein are not limited to the above precise embodiments and that changes may be made without departing from the scope of the invention as defined by the claims. Likewise, it is to be understood that the invention is defined by the claims and it is not necessary to meet any or all of the identified advantages or objects of the invention disclosed herein in order to fall within the scope of the claims, since inherent and/or unforeseen advantages of the present invention may exist even though they may not have been explicitly discussed herein.

What is claimed is:

1. A communications system for providing alerting services, comprising:
a plurality of communication server devices distributed throughout a geographical area and adapted to receive, store and transmit alert information associated with an external event;
an alerting component adapted to generate and transmit the alert information, and further adapted to direct one or more of the plurality of communication server devices to transmit the alert information to at least one user device;
a transmission network including a plurality of transmission routes between the plurality of communication server devices, the alerting component and the at least one user device, the transmission network being adapted to transmit the alert information via one or more of the plurality of transmission routes between any two communication server devices; and
wherein the plurality of communication server devices store substantially the same alert information at any given time.

2. The system of claim 1, wherein the at least one user device operates on one or more communication networks; and
wherein the one or more communication networks include at least one of a public switched telephone network (PSTN) network, an Internet Protocol (IP) network, a cellular network, a radio network and a satellite network.

3. The system of claim 1, wherein the alert information is generated as at least one of a voicemail, a voice message, a text (SMS) message, website content and an email.

4. The system of claim 1, wherein the alert information is generated by an operator in relation to the external event.

5. The system of claim 1, wherein the alert information is pre-generated for a specific type of external event.

6. The system of claim 1, wherein the alerting component is managed via an Internet-based interface.

7. A communications system, comprising:
a plurality of communication server devices distributed throughout a geographical area and adapted to receive, store and transmit alert or call information;
a communication management component adapted to transmit the alert or call information, and further adapted to direct one or more of the plurality of communication server devices to transmit the alert or call information to at least one user device; and
a transmission network including a plurality of transmission routes between the plurality of communication server devices, the communication management component and the at least one user device, the transmission network being adapted to transmit the alert or call information via one or more of the plurality of transmission routes between any two communication server devices;
wherein one or more of the communication server devices are configured to act as master nodes controlling a plurality of other communication server devices configured to act as slave nodes; and
wherein at least one of the communication server devices acting as slave nodes is configured to reconfigure itself to act as a master node upon detection, in any manner, of degraded performance of a master node.

8. A communications system, comprising:
a plurality of communication server devices distributed throughout a geographical area and adapted to receive, store and transmit alert or call information;
a communication management component adapted to transmit the alert or call information, and further adapted to direct one or more of the plurality of communication server devices to transmit the alert or call information to at least one user device; and
a transmission network including a plurality of transmission routes between the plurality of communication server devices, the communication management component and the at least one user device, the transmission network being adapted to transmit the alert or call information via one or more of the plurality of transmission routes between any two communication server devices;
wherein at least one of the communication server devices is configured to re-route alert or call information from one transmission route to another transmission route in response to detected degradation of performance of the one transmission route.

9. A method of providing alerting services, the method comprising the steps of:
providing a plurality of server devices distributed throughout a geographical area and adapted to transmit, receive and store communication data including alert information;
providing a transmission network having a plurality of communication links capable of transmitting the communication data among the plurality of server devices, the transmission network being adapted to transmit the communication data via a plurality of transmission routes between any two server devices;
providing an alerting service adapted to generate the alert information associated with an external event, the alerting service being in communication with the plurality of server devices via the transmission network;
transmitting, via the transmission network, the communication data from at least one of the plurality of server devices to each of the other server devices such that the plurality of the server devices store substantially the same communication data;
generating, by the alerting service, the alert information;
determining if one or more of the plurality of transmission routes is available;
transmitting, via one or more available transmission routes, the alert information from at least one of the plurality of server devices to each of the other server devices such that the plurality of the server devices store the same alert information; and
transmitting the alert information to one or more communication clients.

10. The method of claim 9, further comprising the step of:
receiving, by the alerting service, notification information associated with the status of transmission of the alert information transmitted to the one or more communication clients;
generating timestamps associated with each of the generation of alert information, the transmission of alert information to the plurality of server devices, the transmission of alert information to the one or more communication clients, and receiving the notification information; and
recording, in a log file, the alert information, the notification information, the timestamps, and transmission information associated with all transmissions of the alert information.

11. A communication system for alerting users of an emergency event, comprising:
a plurality of server devices located in various geographical locations, each of the plurality of server devices adapted to store substantially the same communication data;
a network of transmission links connecting each of the plurality of server devices with at least one other of the server devices and capable of connecting at least one of the plurality of server devices to one or more user communication devices for transmitting alert information;
a computer-implemented alerting component for generating alerts associated with the emergency event, and further adapted to direct the plurality of server devices to transmit the alert information, via the network of transmission links, to the one or more user communication devices; and
a computer-implemented logging component for logging transmission information associated with the transmission of the alert information.

12. A method for providing communication services, comprising the steps of:
providing a plurality of communication server devices distributed throughout a geographical area and adapted to receive, store and transmit alert or call information;
providing a communication management component adapted to transmit the alert or call information, and further adapted to direct one or more of the plurality of communication server devices to transmit the alert or call information to at least one user device;
providing a transmission network including a plurality of transmission routes between the plurality of communication server devices, the communication management component and the at least one user device, the transmission network being adapted to transmit the alert or call information via one or more of the plurality of transmission routes between at least two communication server devices;
configuring one or more of the communication server devices to act as master nodes controlling a plurality of other communication server devices and configuring the other communication server devices to act as slave nodes; and
reconfiguring at least one of the communication server devices acting as slave nodes to act as a master node upon detection, in any manner, of degraded performance of a master node.

13. The method of claim 12, wherein the reconfiguring step is performed in response to a detection of degraded performance of a master node to be 30% or less than another node.

14. A method for providing communication services, comprising the steps of:
providing a plurality of communication server devices distributed throughout a geographical area and adapted to receive, store and transmit alert or call information;
providing a communication management component adapted to transmit the alert or call information, and further adapted to direct one or more of the plurality of communication server devices to transmit the alert or call information to at least one user device;
providing a transmission network including a plurality of transmission routes between the plurality of communication server devices, the communication management component and the at least one user device, the transmission network being adapted to transmit the alert or call information via one or more of the plurality of transmission routes between at least two communication server devices; and
configuring at least one of the communication server devices to re-route alert or call information from one transmission route to another transmission route in response to detected degradation of performance of the one transmission route.

15. A method for providing value-added functions to a telephone communication, comprising the steps of:
routing a telephone call initiated by a user's telephone device to a call management computer system;
sensing by the call management computer system of a predetermined series of one or more telephone keys activated on the user's telephone device; and
as a result of sensing the predetermined series of telephone keys activated on the user's telephone device, initiating a value-added functionality to the telephone communication by the call management computer system.

16. The method of claim 15, wherein the step of initiating a value-added functionality includes a step of connecting the telephone call to an additional user's telephone device.

17. The method of claim 15, wherein the telephone call connects the user's telephone device to a second user's telephone device and the step of initiating a value-added functionality includes a step of connecting the telephone call to at least a third user's telephone device.

18. The method of claim 15, wherein the predetermined series of keys includes a star key “*” followed by a number key.

19. The method of claim 15, wherein the value added functionality is taken from a group consisting of, adding a participant, dropping a participant, adjusting speaker volume, adjusting microphone volume, recording the communication, muting a participant, un-muting a participant, and requesting an options menu.

20. The method of claim 15, further comprising the step of calculating a financial charge by the call management system for use of the value added functionality.
